(19) United States
(12) Patent Application Publication
(10) Pub. No.: US 2005/0119804 A1
(43) Pub. Date: Jun. 2, 2005

(54) Train playback station and method

(75) Inventor: Michael J. Hawthorne, Arlington, TX (US)

Correspondence Address: BARNES & THORNBURG, 750-17TH STREET NW, SUITE 900, WASHINGTON, DC, 20006, US

(73) Assignee: New York Air Brake Corporation

(21) Appl. No.: 11/022,661

(22) Filed: Dec. 28, 2004

Related U.S. Application Data
(63) Continuation of application No. 10/751,945, filed on Jan. 7, 2004, now Pat. No. 6,856,865.
Application No. 10/751,945 is a division of application No. 10/301,729, filed on Nov. 22, 2002, now Pat. No. 6,789,005.
Application No. 10/751,945 is a continuation of application No. 10/212,782, filed on Aug. 7, 2002.

(51) Int. Cl. G06F 17/00

(52) U.S. Cl. 701/19

(57) ABSTRACT

A portable train simulator, including a microprocessor, a display and an input device for the microprocessor. A first program drives the display to depict indicia of a control stand and to respond to control inputs from the input device. A second program drives the display to depict a track to be traversed from a data file in response to the control inputs. A virtual control stand is one of the elements that allows the true portability of a train simulator. The system can display and switch between the present operating parameters of the train and/or a history of the operating parameters of the train, as selected by the input device. Video images of the track are simultaneously recorded with and correlated to the operating parameters of the locomotive for play back.

### CROSS-REFERENCE

This application is a continuation of U.S. patent application Ser. No. 10/751,945 filed Jan. 7, 2004, which is a divisional of U.S. Pat. No. 6,789,005 filed Nov. 22, 2002, and is a continuation of U.S. patent application Ser. No. 10/212,782 filed Aug. 7, 2002, all of which are incorporated herein by reference.

### BACKGROUND AND SUMMARY OF THE INVENTION

The present invention relates generally to train locomotive simulators and playback stations and more specifically to improvements thereto.

Simulators and playback stations, for example, the Train Dynamics Analyzer (TDA), a long standing Locomotive Engineer training tool offered by the Train Dynamics Services Group of New York Air Brake, have been used to train engineers. The TDA functionality was enhanced to assist in training Locomotive Engineers on how to better handle their trains. Designs of simulators with math models are shown in U.S. Pat. Nos. 4,041,283; 4,827,438 and 4,853,883. Further capability was added to investigate accidents by playing back the event recorder data through the TDA, monitoring critical physical parameters. Through the years, data was collected from instrumented trains and laboratory experiments, allowing the models used by the TDA to be refined. On board data collection for off-loading is shown in U.S. Pat. Nos. 4,561,057 and 4,794,548.

As more Locomotive Engineers became familiar with the TDA display through training sessions, it became apparent that a real-time version of the TDA in the cab of a locomotive would offer substantial benefits in improved train handling. Earlier designs for on board computer controllers are shown in U.S. Pat. No. 4,042,810 with a description of math models. A Locomotive Engineer Assist Display and Event Recorder (LEADER) system, as described in U.S. Pat. No. 6,144,901, is a real-time, enhanced version of the Train Dynamics Analyzer (TDA).

The LEADER system has the ability to display a real-time or “live” representation of a train on the current track, the trackage ahead, the dynamic interaction of the cars and locomotives (both head end and remote), and the current state of the pneumatic brake system. As a tool for the Locomotive Engineer, the LEADER system allows insight into the effect of throttle changes and brake applications throughout the train providing feedback and information to the Locomotive Engineer not currently available. The information offered by the LEADER system provides an opportunity for both safer and more efficient train handling leading to enormous potential economic benefits.

The LEADER system has all the necessary information to predict the future state of the train given a range of future command changes (what if scenarios). With this ability, LEADER can assist the railroads in identifying and implementing a desired operating goal; minimize time to destination, maximize fuel efficiency, minimize in train forces, (etc.) or a weighted combination thereof. LEADER will perform calculations based on the operational goal and the current state of the train to make recommendations to the Locomotive Crew on what operating changes will best achieve these goals.

TDAs are usually available at a training site and are not typically mobile or portable. Also, LEADER systems are available on the train and are also generally not portable. There is a need in the industry for a truly portable simulator and playback station. One of the limitations of providing a truly portable simulator is a need to provide a control stand that replicates the actual control devices on a locomotive. These include propulsion and multiple braking control valves.

Displays for train simulators are exemplified by FIG. 5 of U.S. Pat. No. 6,144,901. It includes display of conditions throughout the trains in graphic representation, as well as a display of numerical values. Another type of display, known as a Strip Chart Display, is exemplified by FIG. 5 of U.S. Pat. No. 4,236,215. Both forums provide different kinds of information for different purposes. Although the simulator display of the LEADER system provides forces throughout the train, the Strip Chart provides a historical record in a playback mode of values as a function of time. Also, these systems have either operated in the playback mode or a simulation mode with no crossover.

A playback station according to the present disclosure includes a microprocessor, a display and an input device for the microprocessor. A data file of a video of a track correlated and simultaneously recorded with operating parameters for a run of a train on the track is stored in the work station. A program in the microprocessor plays back the data file by driving the display to selectively depict the operating parameters and the correlated video of the track. The video and the operating parameters may be separately stored and correlated by time stamps.

The operating parameters to be displayed are selected via the input device. The program may drive the display to depict the present operating parameters of the train with the history of the operating parameters of the train at a point on the track selected via the input device. The program may drive the display to switch between the depiction of the present operating parameters of the train and the history of the operating parameters of the train at a point on the track selected via and in response to the input device.

A method of collecting train operational data for playback includes collecting video images of at least a track on which the train moves and time coding the images; collecting operating parameters of the train and time coding the parameters; and storing the time coded video images and the time coded operating parameters in a data file. The images and parameters may be stored in an event recorder on the locomotive.

In a playback mode, the data file would include the track with correlated values of the control stand for a run of a train on the track. The program plays back the data file by driving the display to depict the operating parameters correlated to the track display. The ability to switch from the playback mode to a simulation mode using the playback data is provided.

A playback station, according to another aspect of the present invention, portable or not, includes a microprocessor, a display and an input device for the microprocessor. It also includes a data file of a track with correlated operating parameters for a run of a train on the track. A first program plays back the data file by driving the display to selectively depict the operating parameters correlated to the track either as the present operating parameters of the train or a history of the operating parameters of the train. The operating parameters to be displayed are selected via the input device. The operating parameters of the train may be depicted with the history of the operating parameters of a train at a point on the track selected via the input device. A second program operates the playback station as a simulator using the track of the data file by initially using the operating parameters from the data file as inputs and subsequently using the inputs from the input device to derive the operating parameters.

Other objects, advantages and novel features of the present disclosure will become apparent from the following detailed description when considered in conjunction with the accompanying drawings.

### BRIEF DESCRIPTION OF THE DRAWINGS

FIG. 1 is a perspective view of a portable simulator and playback station, according to the principles of the present disclosure.

FIG. 2 is an illustration of a display of a virtual control stand.

FIG. 3 illustrates a display including a strip chart, according to the principles of the present disclosure.

FIG. 4 is a flow diagram illustrating the taking over or switching between playback and simulation modes.

FIG. 5 is a schematic view of a train yard including an RCL device and centralized storage according to the present disclosure

### DETAILED DESCRIPTION OF THE PREFERRED EMBODIMENTS

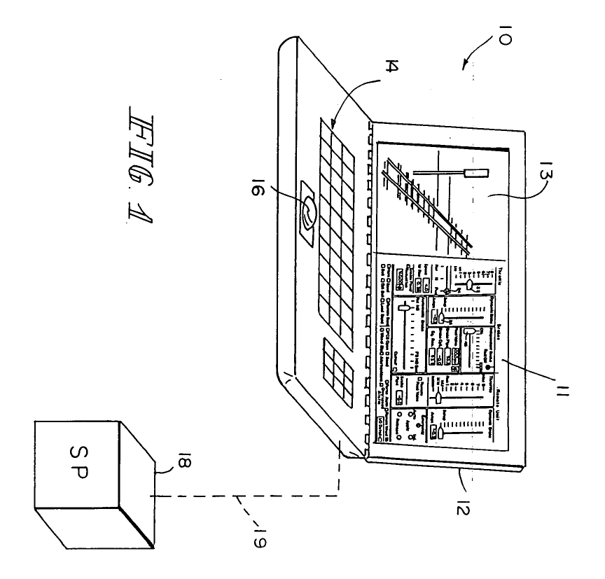

A portable simulator and/or playback device 10 is illustrated in FIG. 1. It is illustrated as a portable, personal computer. It includes a microprocessor and an integral display 12. It includes an input device for the microprocessor. The input devices include a keyboard 14, a mouse 16 or the touch screen of display 12. The program for simulation or playback is included in the microprocessor or may lie in a remote microprocessor 18. The portable simulator 10 may be connected to the remote microprocessor 18 by a network 19. The network may be, for example, the internet.

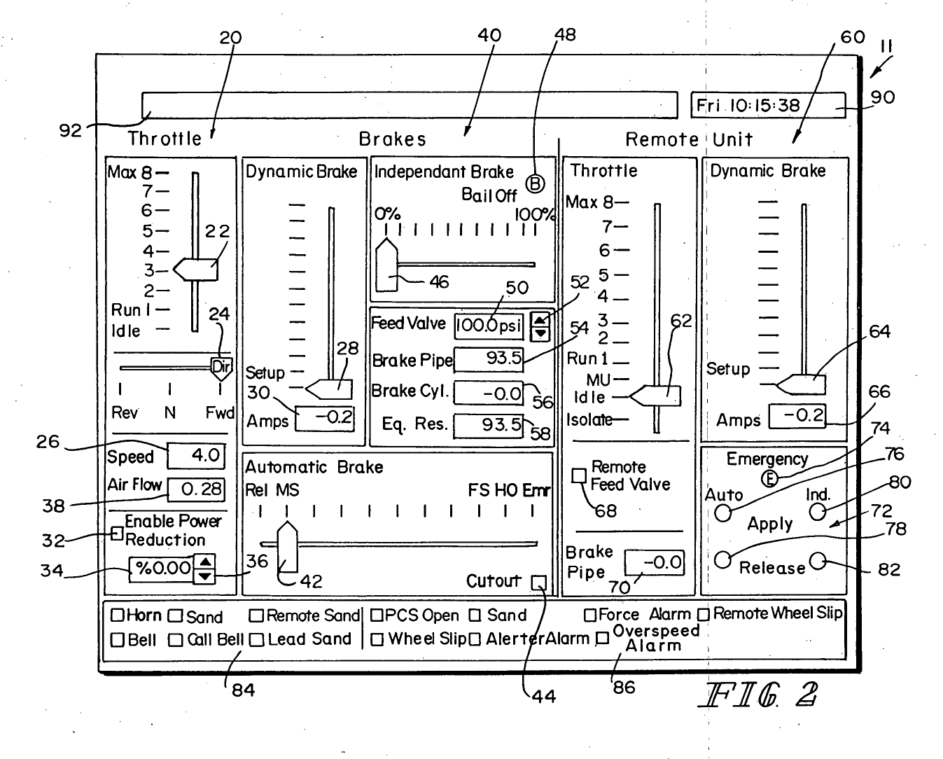

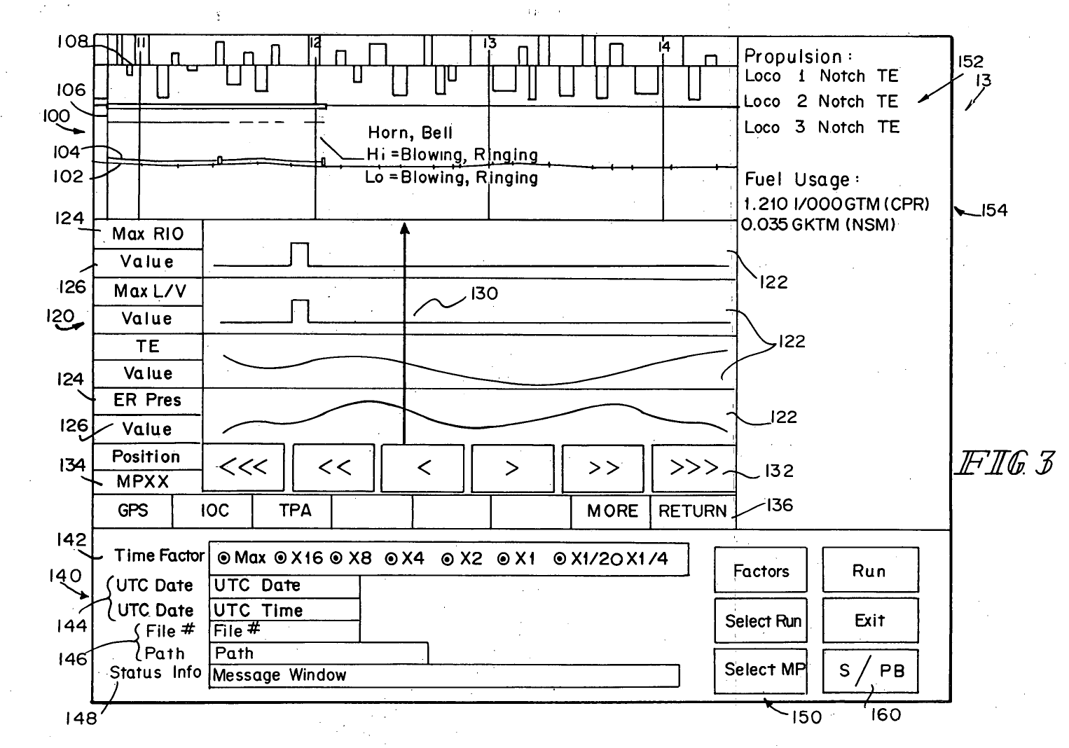

The display 12 may be a split display, as illustrated, with a virtual control stand 11 and a depiction of a track to be traversed 13. One detailed embodiment of the virtual control stand 11 is illustrated in FIG. 2, and one example of the track to be traversed with other information is illustrated in FIG. 3. Alternatively, the displays 11 and 13 may be full-screen displays with the ability to switch there between. As with many other software-based systems, multiple screens may be displayed side-by-side, staggered or full-screen reduced and restored.

An example of a virtual control stand that allows the simulator and playback station to be truly portable is illustrated in FIG. 2. Virtual control stand 11 includes a throttle portion 20 having a throttle position indicator and controller 22 extending between throttle run positions 1 and 8 and idle. It also includes a direction selection indicator 24 between forward, reverse and neutral. The window 26 indicates the speed of the vehicle. The dynamic brake portion indicator and controller 28 is part of the brake control, and the opposite position of the throttle is provided. A window 30 to display the amperes of the dynamic brake and traction motor current (both for DC locomotives) is also provided. An enable power reduction button 32 is provided, as well as an adjustment 36 for the amount of power reduction in window 34. Window 38 illustrates the air flow rate in the brake pipe.

The brake portion 40 of the virtual control 11 includes an automatic brake indicia and controller 42 and an automatic brake cut-out button 44. This is to control the brake pipe for train braking. The independent brake for the locomotive includes an independent brake indicia and controller 46 and a bail-off or actuate button 48. The bail-off button 48 allows release of the independent brakes of the locomotive. Window 50 shows the feed valve value, which is adjusted by button 52. Window 54 illustrates a brake pipe pressure, window 56 the brake cylinder pressure and window 58 the equalization reservoir pressure.

Section 60 indicates the value of the controls for a remote locomotive unit. Slide 62 provides an indication and control of the throttle position, and slide 64 indicates and controls the amount of dynamic brake. Window 66 displays the amperes of both the traction motors and dynamic brake system (for DC locomotives). Button 68 controls the remote feed valve. Window 70 indicates the brake pipe pressure at the remote locomotive unit.

Section 72 illustrates pneumatic brake controls for trains with the remote power. It includes a control 74 for an emergency brake at the remote unit. Buttons 76 and 78 apply and release the automatic brakes, and buttons 80 and 82 apply and release the independent brakes for the remotely controlled locomotives.

Panel 84 depicts the auxiliary functions of the locomotive. These functions both control the function and indicate their status. This includes horn, bell, sand, call bell, remote sand and lead sand. Panel 86 provides indicia depicting the status or warnings. It includes power cutout switch open, wheel slip, sand, alerter alarm, overspeed alarm and remote wheel slip. Window 90 is a clock illustrating the date and time. Window 92 is a screen for miscellaneous messages to the engineer.

The majority of the depicted indicia and controls are those available on a standard control stand. The position of the indicia for the throttle dynamic brake, independent brake, automatic brake and those elements on the remote unit are controlled by an input device. As previously discussed, this may be the keyboard 14, the mouse 16 or a touch screen control. One or more software programs may be provided to drive the display to depict the various elements of the virtual control stand 11, as well as the changing of the controls in response to control inputs from the input device. Other control devices may also be implemented with the virtual control stand 11. These may include combined throttle and dynamic brake and other distributed power interfaces.

The depiction of the track 13 may be a video of the track or CGI, as illustrated in FIG. 1, which shows a track plus a crossing and a signal light. A second program in the portable simulator 10 has data file of the track and provides it as the train moves along the track. This second program is also responsive to the inputs from the first program or control stand to appropriately progress along the track based upon the stored conditions of the track from the data file, as well as inputs from the throttle and brakes from the control stand 11.

Alternatively, the track display 13 may be that illustrated in FIG. 3. The track display portion 100 includes the track profile in three views. The train may be represented on the track in these views. The horizontal view of the track 102 shows the grade in which the train is currently positioned and the grade of the track profile for a number of miles. It shows the geographic shape as a vertical slice of the track profile. An overhead or vertical view 106 incorporates symbols that represent track structure, such as crossing, signals, overpasses, underpasses and sidings. The track curvature representation 108 is made up of blocks that represent track curvature. A block above the dividing line represents a curvature to the right, and a block below the dividing line represents a curvature to the left. The longer the block, the longer the curvature. The higher the block, the more severe the curve. This example of a TDA display or a LEADER display is shown in U.S. Pat. No. 6,144,901.

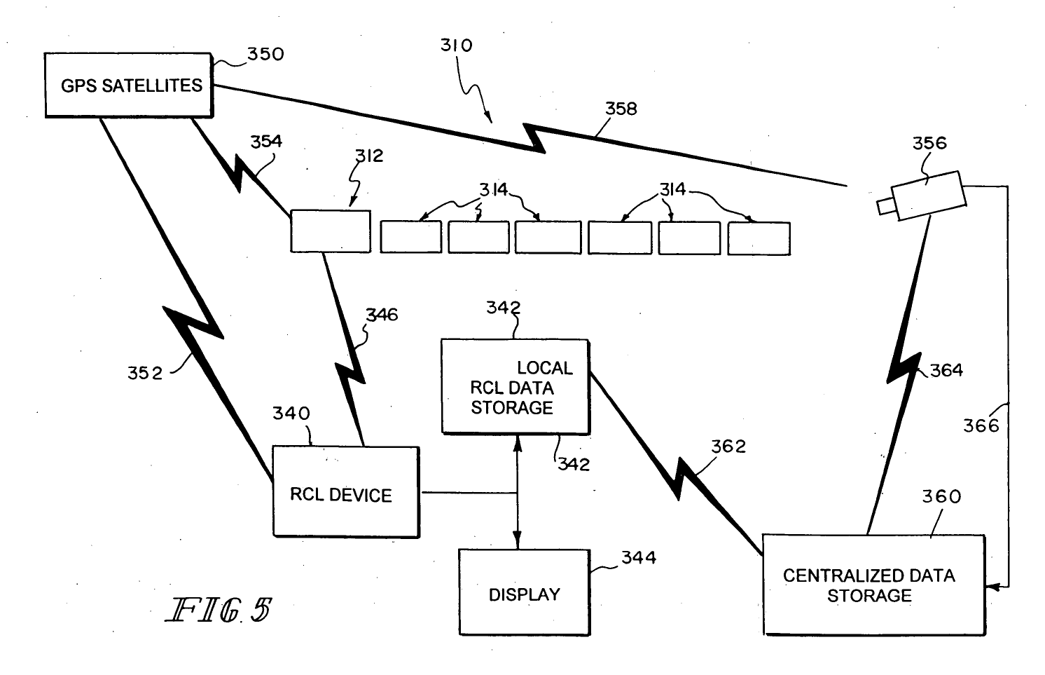

The track view 100 may also be provided in the same software for, and be an alternative to, the graphic or video display of FIG. 1. If the LEADER system is available on the locomotives for that railroad, the LEADER display would be preferable for training purposes. It should also be noted that a fill LEADER display, as shown in FIG. 5 of U.S. Pat. No. 6,144,901, may also be provided in the portable simulator 10.

The display of operating parameters may be on the virtual control stand 11, as shown in FIG. 2, or part of the track display 13, as shown in FIG. 3. Whereas the control stand display of operating parameters is for the present operating parameter, the display in the track portion 13 is correlated to the track position and represents a history of the operating conditions as the lead locomotive traverses the track. Both may also be displayed. If a standard LEADER-type display is used, the present conditions of the operating parameters would be illustrated as part of the track display 13.

Section 120 of the display 13 of FIG. 3 is a strip chart representation of operating parameters. It illustrates the history of the parameter correlated to the location of the track. Even though the representation 120 in FIG. 3 shows the history of a portion of where the train has not reached yet, in a simulator mode it will display only that portion which the train has traversed. The illustration FIG. 3 is a playback mode wherein the data file includes the depiction of the track and its correlated operating parameters. The operating parameter display may also be configured to show values ahead of the train if so desired by the user in the playback mode.

It should be noted that display 13 of FIG. 3 may be used on any simulator or playback station whether it is portable or not. It may be used with or without a control stand for playback analysis of data collected from a train on a particular run with the operating parameters correlated to the track information.

The Strip Chart Display 120 includes a plurality of graphics 122 illustrating the value of the operating parameter. Window 124 indicates the name of the value, and 126 would display the actual numerical value at the position selected by pointer 130. Controls 132 move the pointer to the position on the track display. The position in miles is indicated in Window 134. A row of buttons 136 provides the standard control of the track display 100. This allows moving of the track display and the correlated operating parameters by time, location or other operational parameters. The zoom in and out control provides the amount of track shown. The movement of the playback may be accelerated, real time or for actual playback speed control.

The operating parameters 124 to be displayed may be selected. These may include, but not be limited to, tractive effort, dynamic brake effort, end of train brake pipe pressure, run in/out (RIO) forces, brake system pressures, lateral over vertical (L/V) force ratio, traction motor current, traction motor voltage, speed, speed limit, acceleration, heading, buff/draft forces, minimum safe brake pipe reduction, actual brake pipe reduction, fuel consumed, horn use, bell use, throttle setting and dynamic brake setting. This system may also automatically identify exceptions, such as overspeed, and highlight these events on the display.

The control section 140 includes the time factor 142, the time and date for the run 144, the file and path number 146 and a miscellaneous status information message window 148. The controls 150 provide control of the time factor 142, the run selection and the select parameter button. It also provides control of a run by a start and stop button, as well as an exit from the program. Display 152 provides the propulsion controller position of each locomotive in the train, as well as provides the fuel usage 154. As previously discussed, the whole history section 120 is displayed in a playback station and only that which has transpired would be displayed in a simulator. The playback system will allow the operator to select a location by track position in either the strip chart representation or the LEADER system representation and be able to flip back and forth between the two. All presented data would be accurate for each screen with the position of the train in the playback being preserved.

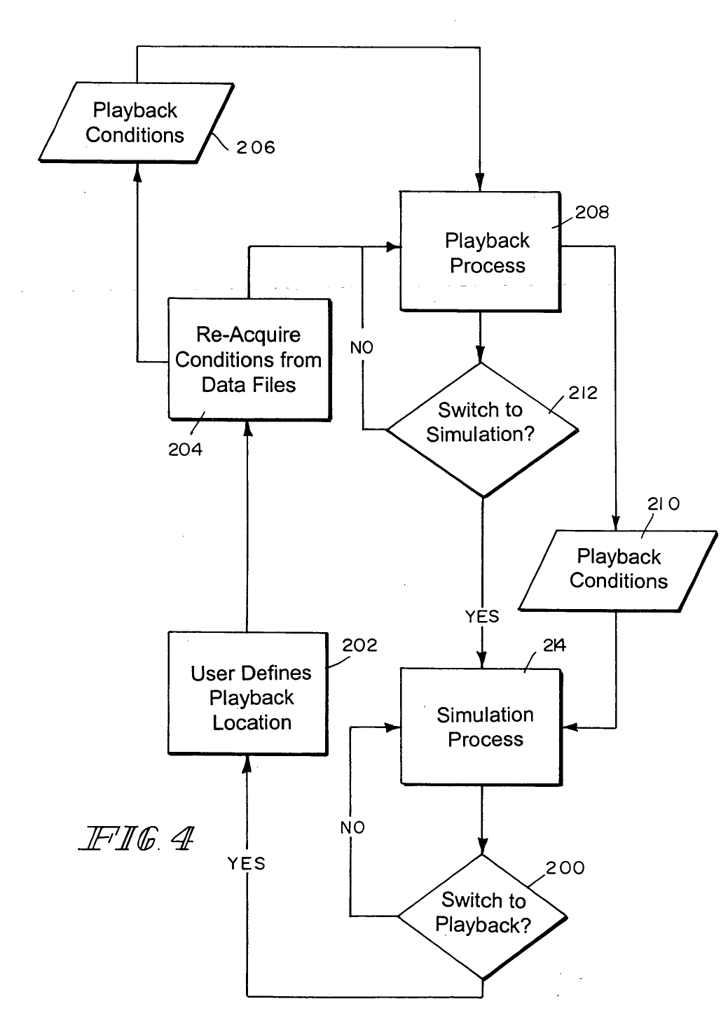

Portable simulator and playback station 10, or any other simulator and playback station, whether portable or not, may also be provided with a program to allow the transition from playback to simulation as illustrated in FIG. 4. During playback process 208, the information from a data file at 204 that has track information correlated with operating parameters, as illustrated in FIG. 3, is played back. The operating parameters may be in the strip chart version, as indicated in 120, or in the numerical values. During playback, the control inputs for the software of the track display comes from the data file 204.

A button 160 allows switching the program from simulation (S) to playback (PB). At the point the button is pushed during playback 208 to switch at 212 to simulation at 214, the track information from the data file is displayed, as well as the operating conditions from the playback source 210 with the initial conditions from the final state of the simulation session. From that point forward, the control signals to drive the track display and the operating parameters display is switched to the inputs from the control stand. It may include a standard control stand or the virtual control stand of FIG. 2. The input signals from the control stand will produce calculable, changing operating parameters versus pre-recorded operating parameters, as well as move the track display at the appropriate rate.

It should be noted that the data file with the correlated operating parameters may be from an actual locomotive, for example, event recorder data, an earlier simulation run or from other sources or forum. The track or time-coded data file may be manually created, for example, by scripting, or can be a modification of pre-existing data to create situations to which the engineer should respond or to supply missing or corrected suspected information in determining the cause of an accident or other failure. An example of collecting and correlating, by example time stamps, a video of the track and the operating parameters is shown on FIG. 5 for a rail yard.

The ability to switch back and forth between playback and simulation allows the operator to try different scenarios in analyzing pre-recorded data to determine appropriate corrective procedures, as well as to adjust the variables to determine causes of pre-recorded existing conditions. If it is a pre-recorded actual run of the engineer, it allows him to make different decisions to see what the results are. After using the system in simulator mode 214, the program can be switched at 200 back to playback mode 208 with the user identifying the desired track position at 202 and the system identifying the initial conditions of the recorded files for that desired track position 204. The playback conditions from 206 are the data for the initial conditions necessary to start the playback process 208

It should be noted that any of the virtual buttons on the screens of FIGS. 2 and 3 may be replaced by actual keys on a keyboard or switches. The virtual presentation is preferred in a portable setting.

As illustrated in FIG. 5, a yard may include the train 310 with locomotive 312 and cars 314, wherein the locomotive 312 is controlled by RCL device 340. The RCL device 340 may include substantially more information and intelligence to be displayed to the operator. It would include a local RCL data storage and program 342 and a display 344. The RCL device 340 has a transceiver to communicate with locomotive 312 via air waves 346. The location of the train on the track within the yard would be determined by the programming storage device 342 and displayed on display 344. This would give the operator a different view point of the locomotive within the yard, which would not be available from his perspective. This is especially true since the operator of the RCL device is generally at ground level. The locomotive 312 generally has a GPS device receiving signals from a satellite 350 via link 354. This information can be conveyed to the RCL device 340 to aid in locating the device's current position in the pre-stored data base for the track or yard at 342. The RCL device may also include a GPS transponder receiving signal by 352 from the satellite 350. This will determine its position within the yard. The device 342 would include software equivalent to that of the LEADER technology. This will allow the system 342 to drive the display 344 to show not only the location of the train 310 on the track or within the yard, but also allow display of forces throughout the train 310. This is important in the control and operation of the train 310 within the yard.

Also, within the yard, are generally cameras 356, which may include a GPS device communication with the GPS satellite 350 via radio link 358. The cameras 356 may also be connected with a centralized data storage 360 via radio link 364 or by hard wire 366. The transceiver of the RCL device 340 also can communicate with the centralized data storage 360 via radio link 362. The centralized data storage 360 correlates the telemetry of the train 310 with the commands from the RCL device 340 for further use. It also may be correlated with the video from the camera 356. This is achieved through time-stamp of the information from the locomotive 312 and the RCL device 340. This is correlated with the time-stamped information from the camera 356. By using the time stamp received from the GPS satellite 350, the accuracy and ease of correlation of information from the locomotive 312, RCL device 340 and camera 356 is increased.

The centralized data storage 360 may collect information from other locomotives and RCL device 340 within the yard. This information may also be transmitted from the locomotive and RCL devices to other RCL devices for displaying of their positions in the yard on the display 344 of the RCL device 340. That would allow an operator to know where other operators are in the work environment. Also, a tag may be worn by yard workers that would also transmit its position. That would allow locomotive operators (RCL or onboard) to know where other workers wearing tags are located and add a measure of safety. The software would include the ability to avoid co-occupation of any workspace by a locomotive and an RCL device (collision avoidance based on telemetry calculations).

The centralized data storage 360 allows playback of the information for management control and accident analysis of the yard. As in other LEADER systems, in playback, a simulation can take place by varying the telemetry of the train to see what results would occur. The software 342 has the ability of performing playback locally. The centralized data storage 360 may be at any remote location, for example, the tower in the yard.

As shown in U.S. Pat. No. 6,622,068, locomotives may have cameras to view the conditions down the track from the front of the train. The images from the camera may be viewed simultaneously with the LEADER display as described in the patent. According to the present disclosure, these images may also be time stamped and stored as video images with the operating parameters in the event recorder on the locomotive and/or the centralized data storage 360. This will make them available for play back on any playback device be it stationary or portable.

Although the present invention has been described and illustrated in detail, it is to be clearly understood that the same is by way of illustration and example only and is not to be taken by way of limitation. The spirit and scope of the present invention are to be limited only by the terms of the appended claims.

1. A playback station comprising:
a microprocessor;
a display;
an input device for the microprocessor;
a data file of a video of a track correlated and simultaneously recorded with operating parameters of a train for a run of the train on the track; and
a program for playing back the data file by driving the display to selectively depict the operating parameters and the correlated video of the track.

2. The playback station according to claim 1, wherein the operating parameters to be displayed are selected via the input device.

3. The playback station according to claim 1, wherein the program drives the display to depict the present operating parameters of the train with the history of the operating parameters of the train at a point on the track selected via the input device.

4. The playback station according to claim 1, wherein the program drives the display to switch between the depiction of the present operating parameters of the train and the history of the operating parameters of the train at a point on the track selected via and in response to the input device.

5. The playback station according to claim 1, wherein the video and the operating parameters are separately stored and correlated by time stamps.

6. A method of collecting train operational data for playback comprising:
collecting video images of at least a track on which the train moves and time coding the images;
collecting operating parameters of the train and time coding the parameters; and
storing the time coded video images and the time coded operating parameters in a data file.

7. The method according to claim 6, wherein the images and parameters are stored in an event recorder.
